(19) United States
(12) Patent Application Publication
(10) Pub. No.: US 2014/0325090 A1
(43) Pub. Date: Oct. 30, 2014

(54) DISCOVERY AND DISCONNECTION OF CLIENT ADDRESSES IN AN ACCESS NODE FOR AN IP NETWORK

(71) Applicants: Roberto Michelin, Genova (IT); Ole Helleberg Andersen, Bording (DK)

(72) Inventors: Roberto Michelin, Genova (IT); Ole Helleberg Andersen, Bording (DK)

(73) Assignee: TELEFONAKTIEBOLAGET L M ERICSSON (PUBL), Stockholm (SE)

(21) Appl. No.: 14/354,989

(22) PCT Filed: Oct. 31, 2011
(86) PCT No.: PCT/EP2011/069157

§ 371 Date: Apr. 29, 2014

(51) Int. Cl. H04L 29/12

(52) U.S. Cl. CPC H04L 61/1541; H04L 61/6022
USPC 709/245

(57) ABSTRACT

A method of operating an Access Node (AN) includes polling a client by periodically causing a query message to be sent to each client that has established a communication link with the AN, and listening for a response message from the client. In one aspect, if the response contains a valid link-local address as the source address of the client, but for which the AN has no record of the Media Access Control (MAC)-Internet Protocol (IP) address-relation, then the AN performs a Duplicate Address Detection (DAD) operation towards the IP network. If no collision is detected enforces the MAC-IP address relation for the link-local address of the client. In another aspect, if the client does not respond, and the AN has a record of an existing removable MAC-IP address-relation for the client, the AN removes that existing removable address-relation.

### TECHNICAL FIELD

The present invention relates to the discovery and disconnection of addresses used by clients connected to an Access Node that provides access to an IP network, and especially an IPv6 network.

### BACKGROUND

FIG. 1 illustrates schematically the broadband signal connections by which end users, or clients access an IP telecommunications/data network. The end users 10, which, for example, may comprise Customer Premise Equipments (referred to hereafter as CPE clients) connect via a wired or wireless connection to a Residential Gateway (RG) 16, which in turn is connected to an Access Node (AN) 12. Typically the CPE clients 10 may connect through a Local Area Network (LAN) with broadband connections being provided to the clients on the LAN via the RG 16. The AN 12 then connects via an aggregation network 18 to a Broadband Network Gateway (BNG) forming part of the IP network.

An important aspect of the signal routing is in the use of addresses. Typically, the CPE clients 10 will use a Link-Local address, although in some cases a corresponding Global-IP or other unicast address may also be used. These addresses are referred to generally below as a client's source addresses. However, for the IP network an IP address (IPv4 or IPv6) is used, while the AN 12 identifies each interface connected to it using a Media Access Control (MAC) address plus other relevant information (such as line id etc.). Note that the MAC address may relate to an interface of an RG 16, or to that of a CPE 10, either of which may be considered a ‘client’ of the AN 12. Thus, references hereafter to a client may be considered to relate to either a CPE or an RG, unless specifically indicated otherwise. The MAC address is thus associated with one or more source addresses used by the client and so, for example, the MAC-IP address relation could relate to one or more associated client unicast addresses that are either link-local addresses or a Global IP addresses. Also, a client may be assigned multiple IP addresses, giving rise to multiple MAC-IP relations.

Additionally, client equipment uses a solicited node multicast address for the purpose of sending out messages to ensure that the subscriber connectivity is not impacted. These are used by the client to send an all-nodes message for a tentative address that the client wishes to use, and to which each interface must respond, and also to send/receive Multicast Listener Discovery (MLD) messages and to perform Duplicate Address Detection (DAD) as discussed further below.

The 3GPP Broadband Forum specification TR-101 ‘Migration to Ethernet Based DSL Aggregation’ (April 2006) requires that, at least for the most general situations, the AN 12 learns the relation between a MAC address and an IP address and enforces this relation so that only traffic to and from a single CPE/client node can use that IP address. This functionality is used to prevent MAC and IP spoofing, to limit the number of MAC addresses a client can use, and to filter downstream Address Resolution Protocol (ARP) traffic, so that this traffic is only forwarded to lines where there is a node with the IP address in question. For IPv4, the ANs have implemented this functionality based on snooping of Dynamic Host Configuration Protocol (DHCP) traffic. On lines configured for “Static IP”, the AN detects the first client (MAC address) that uses a legal IP address on the line, and enforces the MAC-IP address relation. For IPv6, this method continues to be recommended by the Broadband Forum. The newly released TR-177 ‘IPv6 in the context of TR-101’—November 2010, at section 5.5, refers to the filtering methods described in TR-101.

The ANs of some equipment providers enforce the MAC/IP relation throughout the IP lease time, as specified via DHCP. However, as will become evident from the discussion below, this can lead to an excessive number of MAC/IP relations having to be stored in the AN's enforcement tables. Another possibility, considered by some other equipment providers, is to implement a timeout, so that the MAC/IP relations are deleted for nodes that are no longer active. The problem with this is that timing out a MAC/IP relation prevents traffic from being forwarded to a client that is turned on, but sending no traffic itself. The AN would incorrectly block this traffic.

IPv6 supports two methods of address auto-allocation, Stateful Address Allocation via DHCP, and Stateless Address Auto Configuration (SLAAC). Support for both of these methods is required by TR-177.

A specific problem arises when SLAAC is used for address allocation. SLAAC is based on a router periodically sending Router Advertisement (RA) messages, specifying an IP prefix to be used for client address configuration. For ANs that enforce the MAC/IP relation throughout the IP lease time, each RA message, snooped by the AN, prolongs the IP lease time for the announced prefix. Consequently, the lease time for the announced prefix could never elapse, and the MAC-IP address relation of every client that has ever been actively connected to the AN, using an address with the announced prefix, can continue to be stored in the AN's enforcement table. As a result a large number of irrelevant MAC/IP relations may be stored, which can include previously connected CPE clients and, for example, test equipment used for fault location. For IPv4 addresses, this has made it necessary to manually release MAC/IP relations that are no longer valid. Also, with IPv6 and SLAAC, CPE clients can generate a new interface ID (unless the interface Id is required to be strictly related to the MAC address), and thereby new Link-Local and Global IP addresses, every time they start up. Previously used client addresses must therefore be removed from the AN's enforcement table to prevent the table from growing continuously.

Another problem that arises with SLAAC is that on start-up a CPE client 10 can auto-associate a Link-Local address and perform Duplicate Address Detection (DAD) without being connected to the AN 12. This results in a so-called ‘hidden node’ when the connection with AN 12 is (re)established. The problem may be understood with reference to FIG. 2, which shows, for the normal situation, how the signaling would take place if the client 10 was connected to the AN 12 throughout the DAD procedure. At step 201, the Client selects a Link-Local address in accordance with its normal procedure. To start with the selected address is only a tentative address because the client must first ensure that it is free to use it without a collision with another node using that address. This results in it sending a Multicast Listener Discovery (MLD) Report at step 202, which enables the AN 12 to register the client's solicited node multicast address for subsequent action (i.e. for completion of the DAD procedure).

The MLD Report is forwarded, at step 203 to the BNG 14. The client 10 then performs DAD beginning with a Neighbour Solicitation (NS) message 204 which is multicast using the solicited node multicast address of the selected (tentative) address to all connected nodes, including the AN 12, and on to the BNG 14 (step 205). The DAD procedure includes a timer so that the client 10 waits to see if it receives a NS or Neighbour Advertisement (NA) indicating that there is a collision (duplicate address). If no NS or NA with the same tentative address is received before the timer times out, the procedure is repeated a second time (steps 206 and 207). After that, if no collision is detected the DAD procedure is complete and the client is free to continue using the selected Link-Local address.

However, if the DAD process is not fully completed in the extent of the network, for example if the client 10 is not connected to the AN such that the MLD and NS messages sent at steps 202, 204 and 206 do not reach the AN 12 or the BNG 14, and no NS or NA message could be sent back to the client 10 from the IP network if there was a collision. The client 10 considers its address valid because the DAD timer has expired without receiving a NS or NA from the network, but this is only because the network was not connected, and the DAD process has not been verified in the network. In this case of course the AN will not register the MAC-IP relation and will block the access. In other words, if the client 10 was not connected with the AN 12 when it performed DAD (i.e. the CPE client 10 was active on its LAN but it was not yet connected to the AN 12 via its RG 16), and the client subscribes using a solicited node multicast address, then the AN may not be able to snoop and enforce the MAC-IP address relation and the DAD process would have given a false indication—i.e a collision, if present, is not verified.

The hidden nodes problem was recognized during the drafting of TR-177, and the Broadband Forum standardization group, WT 177, proposed a solution known as the draft-krishnan-6man-rs-mark (now draft-ietf-6man-lineid, but referred to hereafter simply as draft-krishnan) to address it. Draft-krishnan specified that the AN has to trigger the sending of an RA message to the edge router of the network when the client connects to the AN. However, the problem is not completely resolved for all the possible situations: in particular the case where a Bridged RG is used to connect to an AN, subtending multiple clients that require different address prefixes to be auto-configured with SLAAC, and in the unfortunate situation where the DAD process is lost. FIGS. 3 and 4 are taken from TR-177 and show the different scenarios for assigning address prefixes with both Bridged and Routed RGs serving multiple CPE clients. Thus, the solution proposed by WT-177 and draft-krishnan addresses the problem of hidden nodes but only for a single address prefix per line, and does not resolve the particular case of having a Bridged RG on a AN line subtending multiple clients that need different Prefixes (i.e. the “B1” and “B2” prefixes shown in FIGS. 3 and 4).

When addresses are allocated via DHCPv6 (rather than using SLAAC), the method used for IPv4 addresses, and specified in TR-101, can also be used for IPv6 addresses. When used for IPv4, the implementation presents a problem because, if the address is considered valid throughout the lease time, then the exchange of a CPE client, for example due to a technical error, may require that the old MAC address of the client be manually released in order to allow the new client to be accepted. On the other hand, if MAC/IP relations for inactive clients (i.e. clients that are available on the line but not active in sending traffic—for example in a server application) are timed out before the lease time has expired, incoming traffic cannot be forwarded to these clients because the AN will block this traffic.

The problems discussed above form the background to the solutions presented below.

### SUMMARY

A method is provided of operating an Access Node, AN, providing an access point for a client accessing an IP network. The AN is configured to enforce a Media Access Control, MAC, address-IP address relation of the client between a MAC address relating to a source address, or identifying part of a source address, used by the client, and an IP address for accessing the IP network. The AN stores the MAC-IP address relation. The method includes polling the client by periodically causing a query message to be sent to each client that has established a communication link with the AN, and listening for a response message from the client.

In one aspect, if the response contains a valid link-local address as the source address of the client, but for which the AN has no record of the MAC-IP address-relation, then the AN performs a Duplicate Address Detection, DAD, operation towards the IP network. If no collision is detected enforces the MAC-IP address relation for the link-local address of the client.

In another aspect, if the client does not respond, and the AN has a record of an existing removable MAC-IP address-relation for the client, the AN removes that existing removable address-relation.

In another aspect an Access Node, AN, provides an access point for a client accessing an IP network, and comprises a memory storing records of MAC-IP address-relations of the client between a source address, or identifying part of a source address, used by the client and an IP address for accessing the IP network. The AN is configured to enforce the address-relation of the client accessing the network, to poll the client by periodically causing a query message to be sent to each client that has established a communication link with the AN, and to listen for a response message from the client.

### BRIEF DESCRIPTION OF THE DRAWINGS

FIG. 1 is a schematic illustration showing the broadband signal connections by which end users, or clients access an IP telecommunications/data network.

FIG. 2 is a signal diagram showing the normal procedure whereby a client connected to an AN selects a Link-Local address and performs DAD.

FIG. 3 is a schematic illustration as shown in the Broadband Forum TR 177 showing the access loops for CPE clients accessing a network via Bridged RGs.

FIG. 4 is a schematic illustration as shown in the Broadband Forum TR 177 showing the access loops for CPE clients accessing a network via Routed or Bridged RGs.

FIG. 5 is a signal diagram showing a procedure whereby an AN discovers a valid source address of a client.

FIG. 6 is a signal diagram showing a procedure whereby an AN removes an address enforcement record of a disconnected inactive client.

FIG. 7 is a flow diagram illustrating the process of discovery of valid source address of a client and removal of an address enforcement record of a disconnected client.

### DETAILED DESCRIPTION

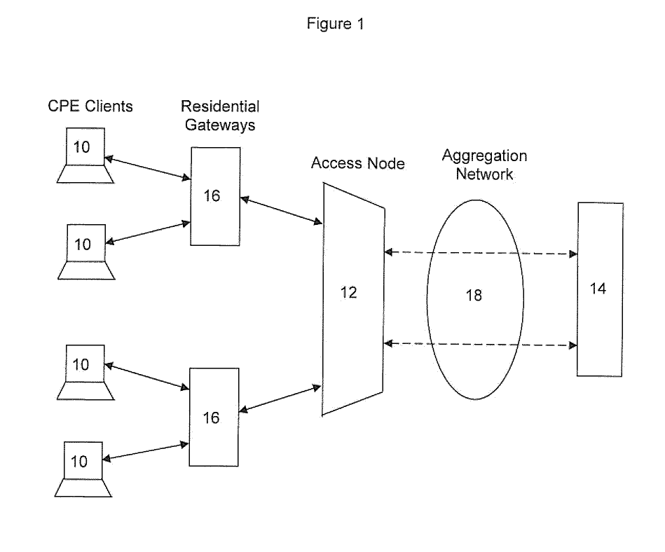

Referring again to FIG. 1, and in accordance with known procedures, the AN 12 enforces the MAC-IP address relations of the client interfaces (CPE clients 10 or RG 16 interfaces) and stores these in enforcement tables. The MAC-IP address relation could relate to an associated source address of the client/interface that might be the Link-Local address, or Global address—in general a unicast address. Note however that with a Global address allocated by the SLAAC method, enforcement is based on the address prefix. The prefix is snooped using Router Advertisement messages from the BNG 14, to determine the prefix(es) that are usable on that connection. Subsequently, the traffic destined for the address is checked and allowed through to the client by the AN 12 based on the prefix.

In the embodiments described herein, MLD queries and responses are used to monitor whether a CPE client is still actively connected to the AN, and to discover potentially hidden nodes. Essentially, the AN polls the connected clients by periodically sending out MLD general queries (or causing the queries to be sent), and listening for the responses. MLD queries are sent to the link-scope all-nodes' multicast address (FF02::1), with a Multicast Address field of 0, which means that any connected CPE (or RG) is required to respond, i.e. both already known clients and ‘hidden nodes’. These MLD general queries and client reports are used as a mechanism for the AN 12 to identify client nodes that are no longer active, so that these nodes can then be released (i.e. their MAC-IP address relation removed from the enforcement table of the AN), as well as to discover ‘hidden nodes’ so that the AN 12 can restart a DAD collision detection procedure towards the IP network based on NS messages on behalf of a discovered hidden node. Note that if the client has been allocated an IPv6 address (i.e. is an IPv6 host) it is already required to subscribe to the Solicited Node multicast addresses of the IP addresses by sending a MLD Join message on the Ethernet link. It is required to do this for Link-Local addresses and, although not mandatory, it is highly recommended for Global addresses as well so that DAD can be performed, in which case the response to the MLD query will use the associated link local address as explained below. This message is repeated if the host is requested to renew the subscription—i.e. it receives a MLD general query.

When the AN 12 receives a response, this will contain an indication of the source Link-Local address that the client is using. An MLD report uses only a Link-Local address as the source address. If the client is using a Global address there will always be an associated link-local address that the MLD response uses, that is associated with the same interface ID as the Link-Local address. The AN then looks to see if it has a record of that address relation in the enforcement table. If it does not have a record, then it assumes that the client has obtained the address and performed DAD limited to the client network and that no duplicate address was detected there without being connected to the IP network (i.e. is a ‘hidden node’). The AN then performs DAD towards the IP network on behalf of the client for that address.

Note that for Global addresses DAD is not always mandatory, although in the 3GPP RFC4862, at section 5.4, it is strongly advised to be done and recommended in any new development. It is useful in case the Interface identifier is not generated with the MAC address but with a randomly generated address (link-local addresses can be generated with a different interface identifier each time they start up). Furthermore, as stated in RFC4862, interface identifiers are not necessarily the same for all unicast addresses on a single interface, in which case DAD is necessary. MLD queries will receive responses for both cases. Thus, the method described can be applied for Global addresses, whether these are DHCP or manually configured.

Also, if there are any MAC-IP address relations in the enforcement table that relate to Link-Local addresses, and the AN does not hear a response before time-out from a client using that link-local address, it assumes that the client is no longer active and so it removes that MAC-IP address (or addresses) relation from the enforcement table.

However, the Global address may be configurable to be either removable or not-removable. This would apply to global addresses that are manually or DHCPv6 configured. In that case, if there are any MAC-IP addresses in the table that relate to a Global address (manually or DHCPv6-configured), and the AN does not hear a response before time-out from a client using that Global address, then it either removes or does not remove the MAC-IP address relation from the table depending on the configuration of the Global address (i.e. removable or not removable). DHCPv6-configured Global addresses that are configured as not-removable would not be removed until the lease time has expired, while those manually configured would only be removed manually (i.e. by a specific instruction from the operator).

Finally, if the AN hears a response, but this only contains an unspecified address, the AN assumes that the client is in the process of performing DAD, and waits to hear an NS message from the client.

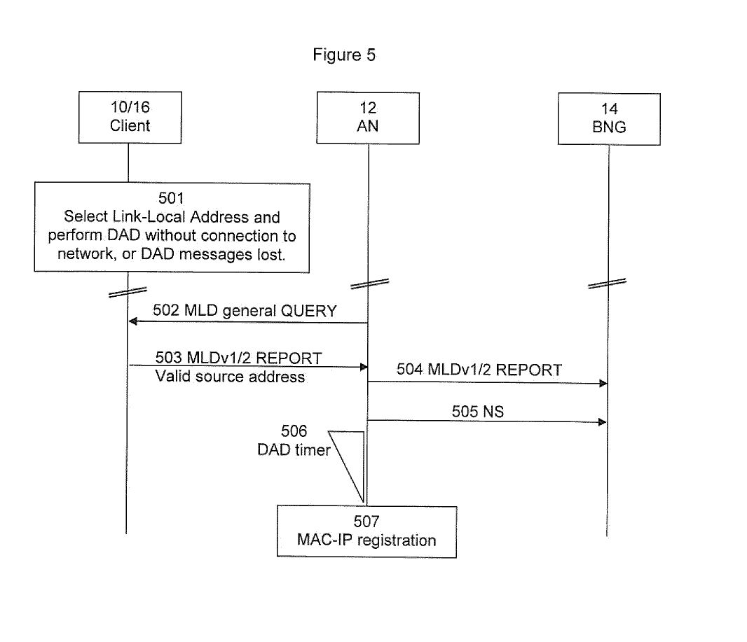

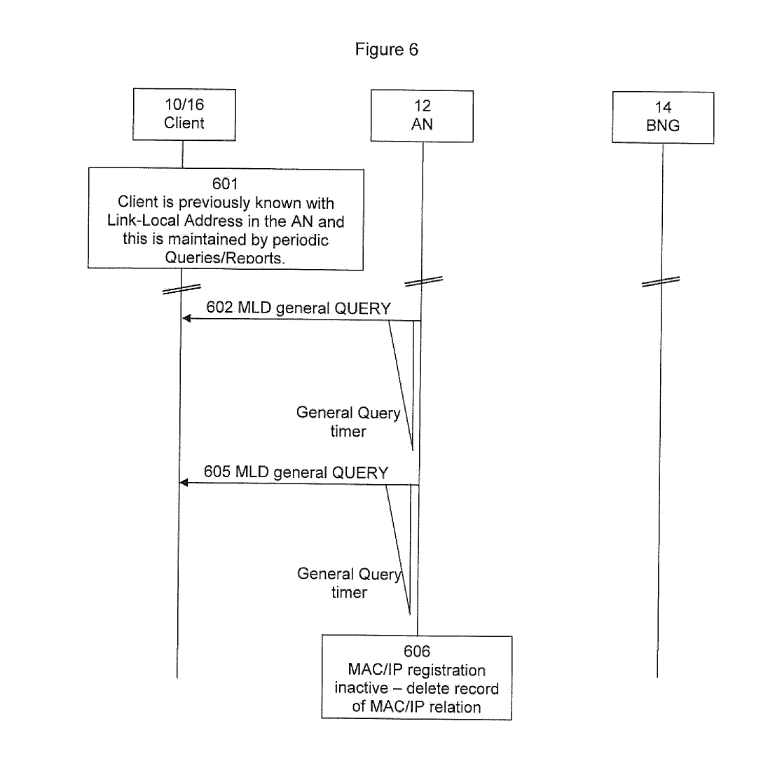

The mechanism described above solves the two problems of discovering ‘hidden nodes’ and removing irrelevant MAC-IP address relations from the AN's enforcement table. These two aspects are described separately in relation to two use cases shown in FIGS. 5 and 6.

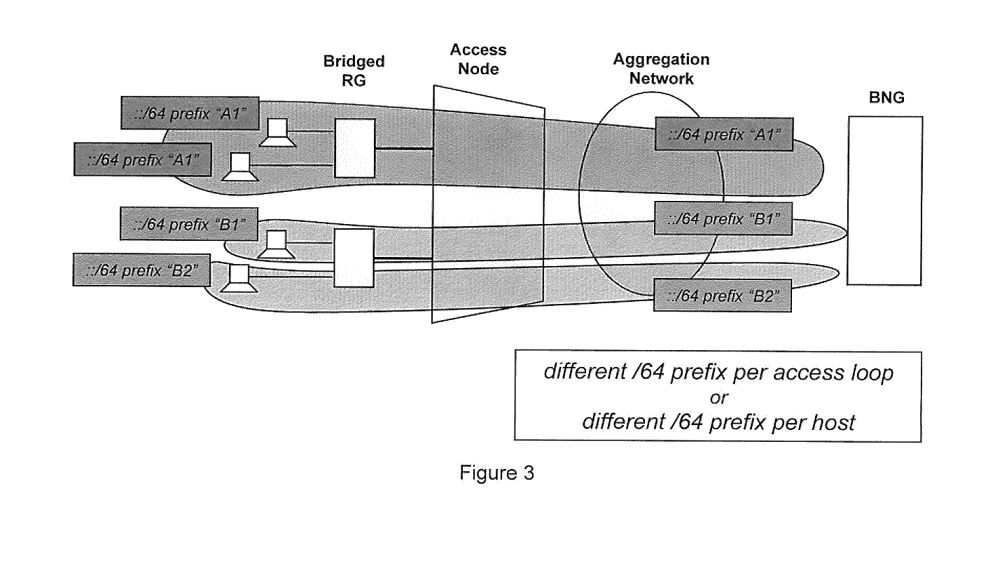

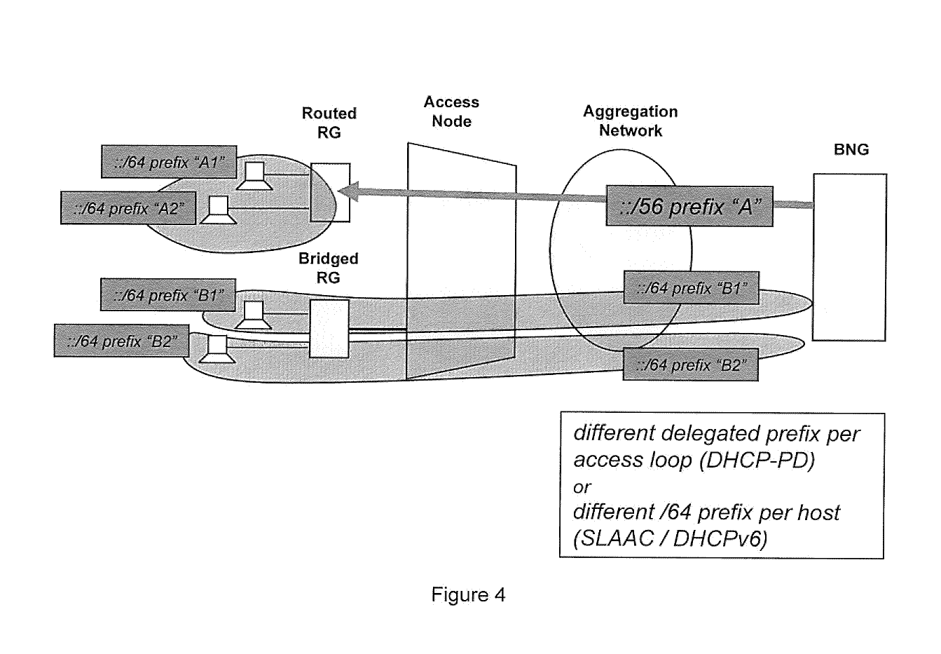

The methods described by WT 177 do not seem to be able to discover hidden nodes when the SLAAC mechanism is used for address allocation in a situation where a bridged RG has subtending CPEs that need to use a different prefix (see FIGS. 3 and 4). The methods described in draft-krishnan rely on the AN creating a Router Solicitation (RS) with an unspecified address as the source address of this RS, which is then tunneled towards the edge Router. This works for situations where a common Prefix is sent to the connected CPEs, but it is not apparent how it could be possible for the AN to discriminate between different multiple CPEs that need different prefixes.

As described above, the solution presented here is that the AN generates periodic MLD general queries in order to discover the Link-Local address of a node that has already performed DAD. (This is not detected by a tunneled RA as required by draft-krishnan.) The AN must distinguish MLD reports on the source address in the messages. If the source address is a valid link-local address, the client has already performed DAD and considers its address to be unique and valid. In that case the AN performs DAD on behalf of the CPE to ensure that the address is also unique in the network. If no collision is detected the relation is enforced. If, on the other hand, the source address is an Unspecified address, the client is assumed to be in the process of performing DAD itself, and the AN should await NS messages from the client.

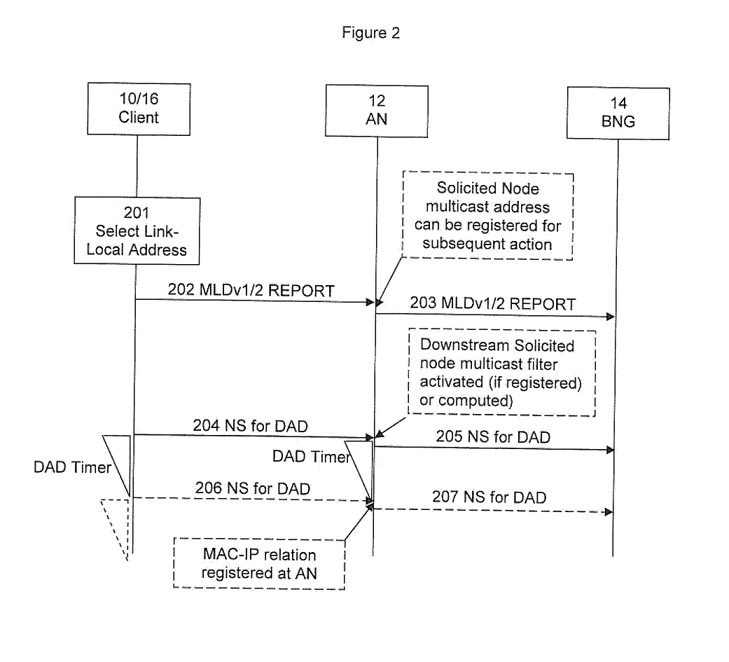

Referring to FIG. 5, client 10 (CPE client or RG) at step 501 selects a Link-Local address and performs DAD, but without having established a connection with the AN 12, or for some reason the line to the AN was unavailable at that time. Later, at step 502, after the client has established a connection, or when the line has become available again, the AN 12 polls all clients connected to it by sending out an MLD general query (or causing the query to be sent). The client 10, on receiving the MLD general query responds at step 503 by sending out an MLDv1/2 Report that includes the Link-Local address it selected at step 501. Note that from the client's point of view this Link-Local address is considered valid because it has completed its own DAD without detecting any collision. At step 504, the AN 12 forwards this MLD Report on to the BNG 14. This is to instruct other possible snoopers to open the door for the joined addresses and also to operate as an unsolicited MLD report to the BNG. The AN 12 also determines if it has no record in its enforcement table of the MAC-IP address relation relating to that Link-Local address. In that case it assumes that it has discovered a ‘hidden node’, and so commences DAD by sending a NS message 505 to the network via BNG 14 and starting the DAD timer. At step 507, the DAD process has completed (timed out) without any collision being detected in the network (no NS or NA messages received), then the AN 12 completes its registration of the client by adding the MAC-IP relation for the client to its enforcement table. (Note that, as described above with reference to FIG. 2, the DAD process would typically involve at least one repetition of the sending of an NS and waiting for the DAD timer to time-out, but for simplicity this is not shown in FIG. 5).

While the prior-art would use either a time-out or a lease time before removing inactive MAC-IP address relations, the solution here is that the AN generates periodic MLD general queries (or causes queries to be sent from an external source) in order to maintain the Link-Local and MAC addresses of nodes that are already known. The AN maintains the MAC-IP relation as long as the client is present and maintains its subscription to the Solicited node multicast address of the Link-Local IP address by answering the MLD general queries. Apart from situations in which manual configuration is being forced, when the client no longer answers, for example because it has been switched off, the MAC-IP relation is in-activated in the AN. When queries are generated by the AN, the activation and periodicity of the MLD queries must be configurable for each virtual connection, as stipulated in 3GPP RFC2710.

Similar functionality can be performed on global IP addresses. If the address was allocated by the SLAAC procedure, or by a removable static IP configuration, the MAC-IP relation can be deleted when the client no longer responds to the MLD query.

Subsequently, the AN can accept a new relation with the same MAC address, i.e. another device may use the IP address. However, If the address was allocated by DHCP, the address must be kept as a resumeable address, allowing the same MAC address to resume using the IP address throughout the lease time. In other words, the lease time for DHCP allocated addresses must be maintained until the lease times out, even if the client is no longer active.

Referring to FIG. 6, client 10 (CPE client or RG) at step 601 has a link local address, for which the AN 12 has a previous record of the MAC-IP address relation in its enforcement table. This record has been maintained by the client responding to the AN's polling (periodically sending of MLD general queries). AS shown, at step 602 the AN 12 sends an MLD general query As no response is received from the client 10 before the General Query timer has timed out, at step 605 the AN 12 sends another MLD general Query. Again the client 10 does not respond because it is no longer active on the connection. Thus, the General Query timer times out without the AN 12 receiving a response and so, at step 606 it deletes the records of the MAC-IP address relations for the client using those MAC addresses. Note that during the time while the general query timer is running, the AN 12 will receive MLD Reports from any other connected CPEs, but these are not shown in FIG. 6.

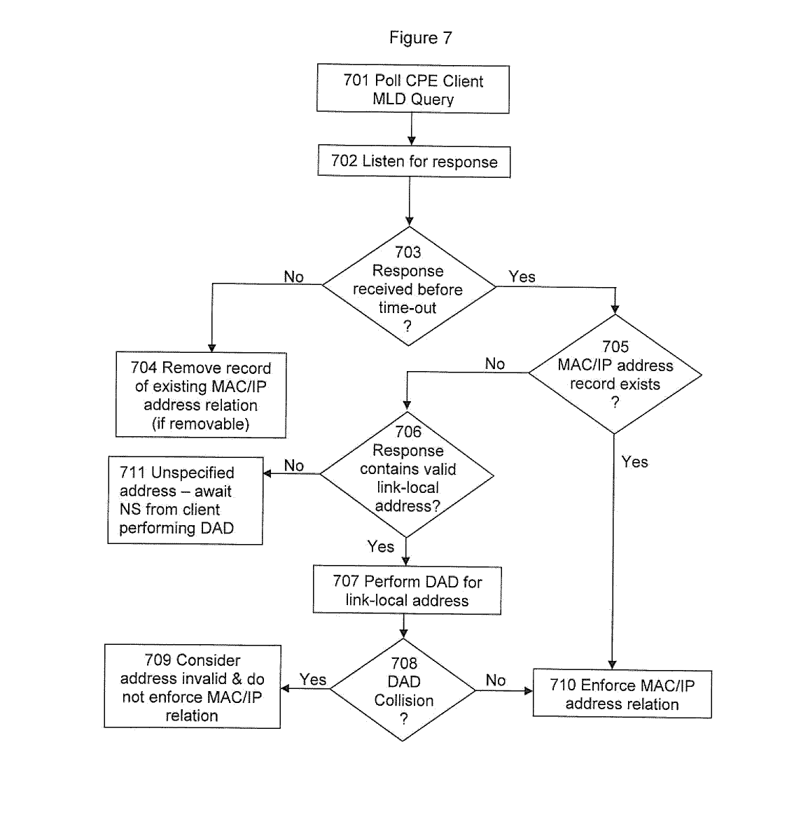

FIG. 7 is a flow diagram illustrating the procedure. At step 701 the AN polls clients by the sending out of an MLD Query, and at step 702 listens for responses (e.g. for the duration of a General Query timer, as shown in FIG. 6). At 703 the AN determines if a response has been received for a particular client for which it has an active MAC-IP relation in its enforcement table. If no response is received, then at step 704 the AN removes the record from its enforcement tables (provided the address is removable i.e. removal is permitted). If a response is received, then at step 705 the AN determines if the MAC-IP address record exists for the source Link-Local address to which the response (MLDv1/2 Report) relates. If the AN has an existing MAC-IP address relation in its table, then it continues directly to step 710 where it continues to enforce the relation.

However, if at step 705 the AN determines that it does not have a record of the MAC-IP address relation for the address indicated by the client in the response, then at step 706 it determines whether or not the address is a valid Link-Local address. If it is a valid address, then the AN assumes that it has discovered a ‘hidden node’ and at step 707 performs DAD for the Link-Local address towards the IP network on behalf of the client. At step 708 the AN determines from NS and NA messages received from the network side, if the DAD has detected a collision and if it has it considers the address to be invalid and so does not enforce the MAC-IP address relation at step 709. Any subsequent traffic sent by the client using that address will then be blocked by the AN. If at step 708, the AN determines that there is no collision then it proceeds to step 710 to enforce the MAC-IP address relation for the newly-discovered client's Link-Local address.

If at step 706 the AN determined that the response it received did not relate to a valid Link-Local address, then the address to which the response relates is an unspecified address, and the AN assumes that the client is in the process of performing DAD. Therefore, at step 711, the AN waits to hear an NS message from the client as part of the client's DAD process. When it receives the NS, it will forward this to the BNG so that the DAD process can be completed towards the network, and, if successful, the client will then have a valid Link-Local address.

The mechanisms described above allow an AN to keep track of a client (CPE client or routed RG) connected on the access line. The AN can delete MAC-IP relations that are allocated by SLAAC or by static IP configuration and that are no longer in use, while still allowing incoming traffic to be forwarded to nodes that are present, but generating no traffic. Furthermore, CPE client replacement and fault location are simplified because the registration of previously active CPE clients and test equipment will time-out automatically. Manual release (by operator command) is not required. This can result in a significant improvement of OPEX costs because it could potentially affect the handling of thousands of nodes in a Customer Access network.

A further advantage is an increase in the speed of client discovery at the AN: because ‘hidden nodes’ are automatically resolved. Also, the use of the MLD query for the discovery of hidden nodes and DAD Neighbor Discovery performed by AN (on behalf of the CPE) means that the BNG can send the correct RAs to the discovered CPEs.

In general, the embodiments described above relate to both IPv4 and IPv6, unless indicated otherwise. For IPv4 there is no SLAAC address autoconfiguration mechanism, but DHCP(v4) or manual configuration are used. However, in cases where IPv4 and IPv6 are present (in dual stack operations) the above mechanisms may provide for removability of IPv4 addresses as well. The introduction of IPv6 is today almost always in such dual stack arrangements, and this situation is likely to continue for many years.

The discovery of hidden nodes for IPv4 is not necessary because there is no autoconfiguration with SLAAC in IPv4. However, although not mandatory in IPv4, in some cases an IPv4 CPE can have an Internet Group Management Protocol (IGMP)-analogous capability to respond at least to queries, in which case the same principles can be applied for IPv4 addresses to improve address management when DHCP/manual configuration is used. In such cases, for IPv4 implementations, the CPE would be configured to implement IGMP responses that are not mandatory.

1. A method of operating an Access Node (AN) providing an access point for a client accessing an Internet Protocol (IP) network, and operative to enforce a Media Access Control (MAC) address-IP address relation of the client between a MAC address relating to a source address, or identifying part of a source address, used by the client, and an IP address for accessing the IP network, and wherein the AN stores the MAC-IP address relation, the method comprising:
polling the client by periodically causing a query message to be sent to each client that has established a communication link with the AN; and
listening for a response message from the client and in response to determining the response contains a valid link-local address as the source address of the client, but for which the AN has no record of the MAC-IP address-relation, then the AN performs a Duplicate Address Detection operation towards the IP network, and in response to determining no collision is detected, enforces the MAC-IP address relation for the link-local address of the client.

2. A method of operating an Access Node (AN) providing an access point for a client accessing an Internet Protocol (IP) network, and operative to enforce a Media Access Control (MAC) address-IP address relation of the client between a MAC address relating to a source address, or identifying part of a source address, used by the client, and an IP address for accessing the IP network, and wherein the AN stores the MAC-IP address relation, the method comprising:
polling the client by periodically causing a query message to be sent to each client that has established a communication link with the AN;
listening for a response message from the client; and
in response to determining the client does not respond, and the AN has a record of an existing removable MAC-IP address-relation for the client, the AN removes that existing removable address-relation.

3. The method of claim 1, wherein the client is one of Customer Premise Equipment (CPE) client and routed Residential Gateway (RG).

4. The method of claim 1, wherein the source address of the client is one of link-local address of the client and Global address of the client.

5. The method of claim 4, wherein the source address is a Global address of the client, the AN enforcing an address-relation between a prefix of the Global address and the IP address.

6. The method of claim 1, wherein the query message sent to each client is a Multicast Listener Discovery (MLD) message.

7. The method of claim 6, wherein the response message from the client is one of Neighbour Solicitation (NS) message and Neighbour Advertisement (NA) message.

8. The method of claim 2, wherein the AN listens for a response for a predetermined query/response time to determine if the client does not respond.

9. The method of claim 8, further comprising, when no response is received from the client during the query/response time, repeating the sending of the query message at least one more time, and listening for a response for a further query/response time before determining that the client has not responded.

10. The method of claim 1, wherein in response to determining the response contains an Unspecified source address, the AN assumes that the client is in the process of a Duplicate Address Detection operation itself, and waits for a further message from the client.

11. The method of claim 1, wherein the AN generates and sends the query message sent to the client.

12. The method of claim 1, wherein the AN causes another network entity to generate and send the query message to the client.

13. An Access Node (AN) providing an access point for a client accessing an Internet Protocol (IP) network, and comprising a memory storing records of Media Access Control (MAC)-IP address-relations of the client between a source address or identifying part of a source address used by the client and an IP address for accessing the IP network, the AN operative to:
enforce the address-relation of the client accessing the network;
poll the client by periodically causing a query message to be sent to each client that has established a communication link with the AN; and
listen for a response message from the client.

14. The AN of claim 13, further operative to, in response to receiving a response that contains a valid link-local address as the source address of the client, but for which the AN has no record of the address-relation in the memory, perform a Duplicate Address Detection operation on behalf of the client towards the IP network for the source address and in response to determining no collision is detected, to enforce the address-relation for the link-local address of the client.

15. The AN of claim 13, further operative to determine if the client has not responded to the query, and the AN has a record of an existing MAC-IP address-relation for the client, to delete that existing address-relation.

16. The AN of claim 15, wherein the AN is operative only to delete the existing address-relation if the relation is designated as removable, and not to delete the relation if it is designated as not-removable.
